(19) United States
(12) Patent Application Publication
(10) Pub. No.: US 2013/0320925 A1
(43) Pub. Date: Dec. 5, 2013

(54) CHARGER AND CHARGING ASSEMBLY HAVING THE SAME

(71) Applicants: Wang-I YU, Jhonghe (TW); Hung-Chi TAI, Jhonghe (TW); Yung-Chih HUNG, Jhonghe (TW)

(72) Inventors: Wang-I YU, Jhonghe (TW); Hung-Chi TAI, Jhonghe (TW); Yung-Chih HUNG, Jhonghe (TW)

(73) Assignee: ALLTOP ELECTRONICS (SUZHOU) LTD., Taicang City (CN)

(21) Appl. No.: 13/547,814

(22) Filed: Jul. 12, 2012

(30) Foreign Application Priority Data
Jun. 4, 2012 (CN) 201210180493.2

(51) Int. Cl. H02J 7/02; B65H 75/38

(52) U.S. Cl. 320/111; 242/388.6

(57) ABSTRACT

A charger includes a reel box, an input port, an output port, restore mechanisms, and a power converter. The input port includes an input cable received in the reel box and an input connector connecting with the input cable. The input cable extends beyond the reel box a certain distance. The output port includes an output cable received in the reel box and an output connector connecting with the output cable. The output cable extends beyond the reel box a certain distance. The restore mechanisms is received in the reel box. The power converter is received in the reel box. One end of the power converter connects with the input port, and the other end of the power converter connects with the output port.

### BACKGROUND OF THE INVENTION

1. Field of the Invention

The present invention relates to a charger and a charger assembly having the same, more particularly to a charger and a charger assembly for charging an electric vehicle.

2. Description of Related Art

TW Patent No. 509214 disclosed a transformer converter having reel structure, especially a transformer converter having a power line which could be automatically drawn back and positioned therein. This is realized by the reel structure disposed in the transformer converter, which has a reel box, a reel plate, and a volute spring. The reel box is arranged in a shell of the transformer converter and has a trunking with the reel plate pivotally received therein. The power line of the transformer converter is reeled on the reel plate with one end thereof which could be adjustably rolled out of the reel box. The volute spring is disposed in the reel box and connected with the reel plate for adjusting the length of the power line according to different needs.

However, only one end of the power line of the transformer converter could be adjustably reeled, while the other end of the power line is an electrical connector which directly connects with an equipment. The inner space of the reel structure only can receive the power line with relatively short length, hence restricting the application situations of the transformer converter having the reel structure.

TW Patent No. 547411 disclosed an improved charging structure for charging an electric scooter aiming at improving the charging inconvenience caused by the conventional charger which is an independent component. The charging structure roughly comprises an electric scooter body and a charger. The charger comprises a power supply circuit, and a charging circuit. A plug is disposed at one end of the charging circuit. The charger is integrally disposed in the electric scooter. A receiving cavity is defined adjacent to a battery box which is located at the bottom of a footstep of the electric scooter body for receiving the charger and positioning the charging circuit and the plug. The power supply circuit of the charter directly connects with the battery of the electric scooter. When charging the electric scooter, dragging out the plug of the charging circuit from the electric scooter could realize the charging of the scooter.

However, the electric scooter is prone to shaking when moving. Since the charger is integrated with the electrical scooter, the electric components equipped in the charger are prone to being hurt by the shaking of the moving electric scooter, thus influencing the service life of the charger.

### BRIEF SUMMARY OF THE INVENTION

Accordingly, an object of the present invention is to provide a charger which is easy to be manufactured and could be used in different charging situations.

Another object of the present invention is to provide a charging assembly having the charger above.

In order to achieve the above-mentioned object, a charger adapted for electrically connecting with a power supply system to charge a battery comprises a reel box, an input port, an output port, restore mechanisms, and a power converter. The input port comprises an input cable received in the reel box and an input connector connecting with the input cable. The input cable extends beyond the reel box a predetermined distance for providing an electrical connection between the input connector and the power supply system. The output port comprises an output cable received in the reel box and an output connector connecting with the output cable. The output cable extends beyond the reel box a predetermined distance for providing an electrical connection between the output connector and the battery. The restore mechanisms are received in the reel box and capable of dragging the input cable and the output cable back into the reel box. The power converter is received in the reel box. One end of the power converter connects with the input port, and the other end of the power converter connects with the output port.

The foregoing has outlined rather broadly the features and technical advantages of the present invention in order that the detailed description of the invention that follows may be better understood. Additional features and advantages of the invention will be described hereinafter, which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is an assembled, perspective view of a charging system in accordance with the present invention;

FIG. 2 is a view similar to FIG. 1, but from a different aspect;

FIG. 3 is an assembled, perspective view of a charger in accordance with the present invention;

FIG. 4 is a view similar to FIG. 3, but from a different view;

FIG. 5 is partially exploded view of the charger shown in FIG. 3 with an upper shell of a reel box removed;

FIG. 6 is a perspective view of a lower shell of the reel box of the charger shown in FIG. 3;

FIG. 7 is a perspective view of a receptacle of a battery shown in FIG. 2; and

FIG. 8 is a perspective view of a terminal of the receptacle shown in FIG. 7.

### DETAILED DESCRIPTION OF THE PREFERRED EMBODIMENTS

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

Reference will be made to the drawing figures to describe the present invention in detail, wherein depicted elements are not necessarily shown to scale and wherein like or similar elements are designated by same or similar reference numeral through the several views and same or similar terminology.

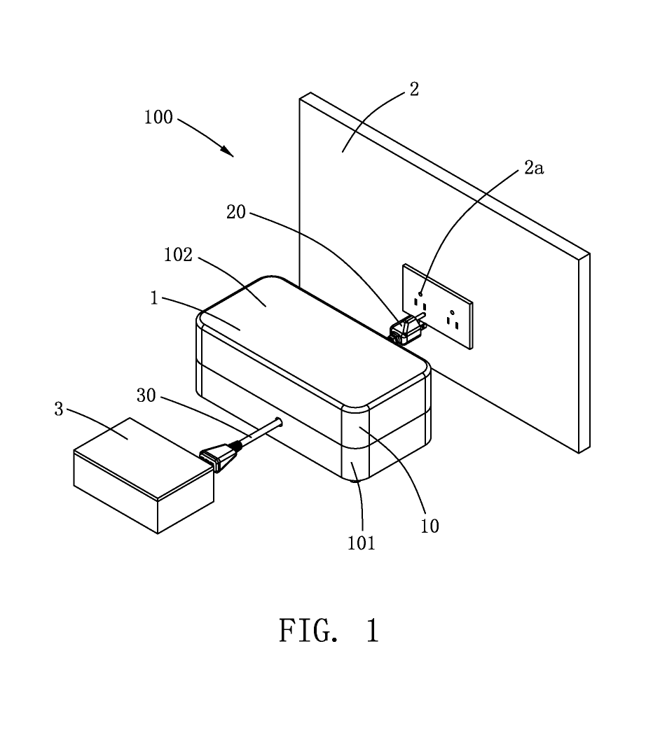

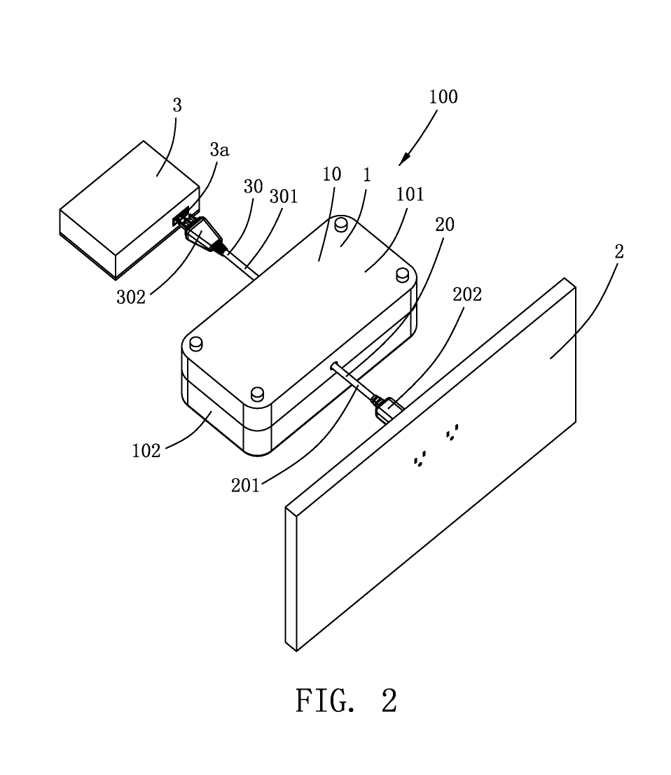

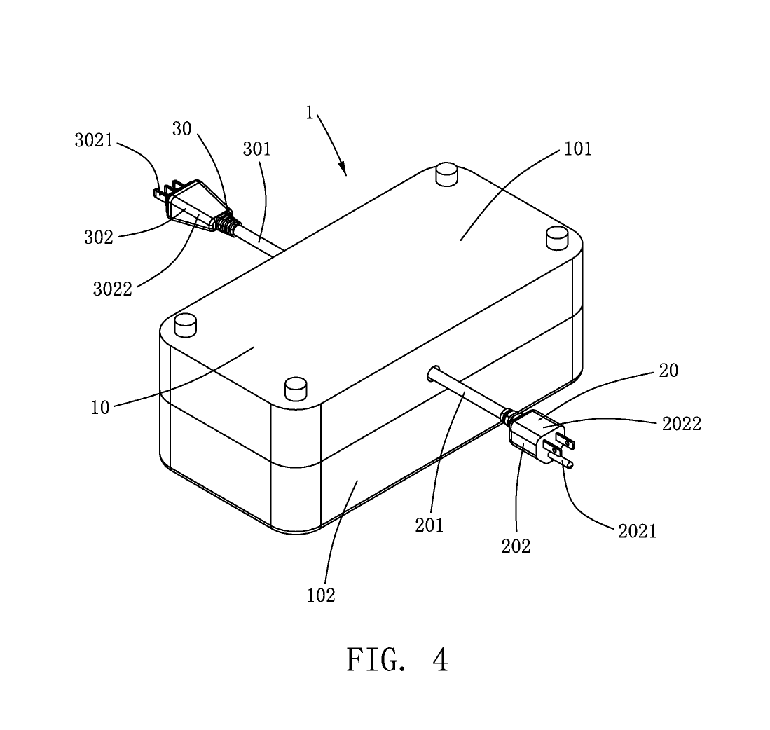

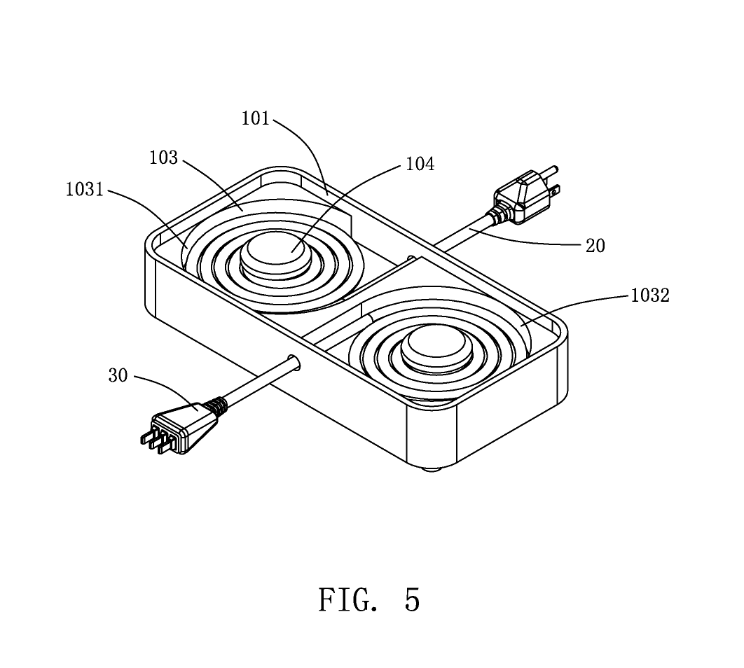

Please refer to FIGS. 1-5, a charging system 100 comprises a charging assembly (not labeled), and a power supply system 2 for providing power. The charging assembly in accordance with the present invention comprises a charger 1 and a battery 3 connecting with the charger 1 for being charged.

In the present invention, the charging system 100 is for charging an electric vehicle. The power supply system 2 could be residential power, reusable energy, such as wind energy, solar power etc. The battery 3 is a common chargeable battery, such as Cd—Ni Battery, Ni—H Battery, Li-ion Battery etc, which could be recyclably charged and discharged to provide power to the electric vehicles. The power supply system 2 provides a receptacle 2a or a power supply connector, such as a tri-hole AC metope socket, to prevent the user from contacting conductive metal, thus preventing an electric shock accident. In the present invention, the battery 3 also provides a tri-hole receptacle connector 3a or a power charging connector.

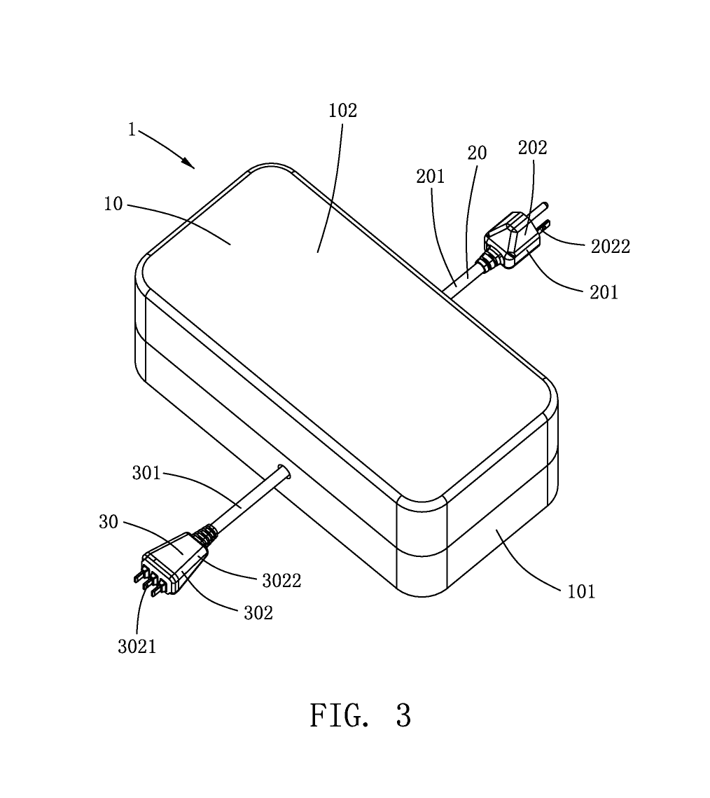

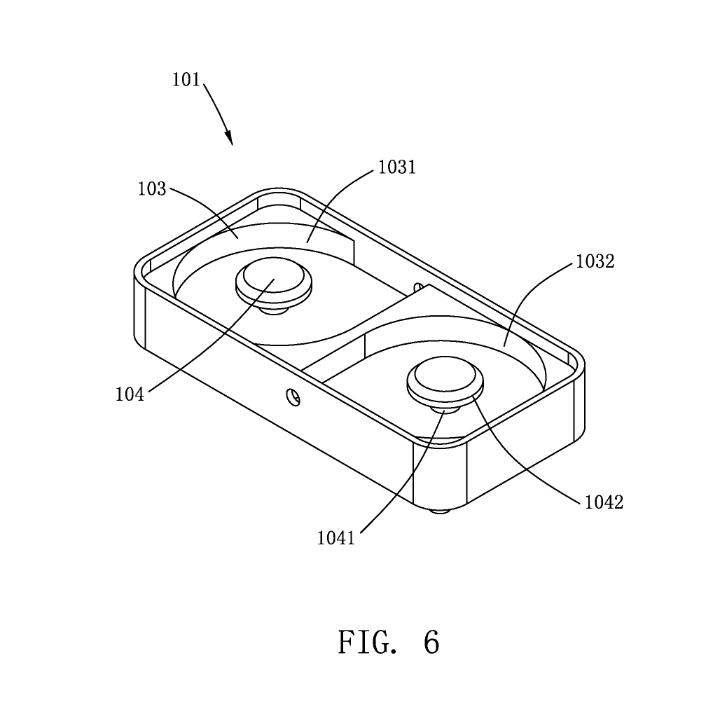

Please refer to FIGS. 3-6, the charger 1 comprises a reel box 10, an input port 20 for electrically connecting with the power supply system 2 and partially received in the reel box 10, an output port 30 for electrically connecting with the battery 3 for being charged and partially received in the reel box 10, restore mechanisms (not shown) received in the reel box 10, and a power converter (not shown) received in the reel box 10. One end of the power converter connects with the input port 20, and the other end connects with the output port 30, thus the power provided by the power supply system 2 could pass through the input port 20, then converted into suitable power for charging the battery 3 by the power converter, then pass through the output port 30 to the battery 3 for charging.

The reel box 10 comprises a lower shell 101 and an upper shell 102 cooperating with the lower shell 101 to form a receiving space 103 therebetween. In the preferred embodiment of the present invention, the receiving space 103 is divided into a first receiving section 1031 and a second receiving section 1032 spaced from the first receiving section 1031. Each of the first and second receiving sections 1031, 1032 is disposed with a protruding shaft 104 which comprises a reel section 1041 with relatively small diameter and an enlarged stop section 1042 with larger diameter and located at a free end of the reel section 1041. The protruding shafts 104 are spacedly arranged.

The input port 20 comprises an input cable 201 received in the first receiving section 1031 of the reel box 10, and an input connector 202 exposed out of the reel box 10 and connecting with the free end of the input cable 201. The input cable 201 has a certain length and is capable of being reeled into the reel box 10. The outer force could pull the input cable 201 out of the reel box 10 a predetermined distance for connecting the input cable 201 to the power supply system 2. The input connector 202 comprises conductive contacts 2021 for electrically connecting with the input cable 201, and an insulative housing 2022 molded over the conductive contacts 2021 for convenient insertion or extraction for the user hand. In the preferred embodiment, the quantity of the conductive contacts 2021 is the same as that of the receptacle 2a, namely three in exact value. When using, the user hand exerts a force to the insulative housing 2022 of the input connector 202 and pulls the input cable 201 out of the reel box 10 until the input connector 202 could be plugged into the receptacle 2a of the power supply system 2 to form an electrical connection with the power supply system 2.

The output port 30 comprises an output cable 301 received in the second receiving section 1032 and an output connector 302 exposed out of the reel box 10 and connecting with the free end of the output cable 301. The output cable 30 has a certain length and is reeled to be received in the reel box 10. An external force could pull the output cable 301 out of the reel box 10 a predetermined distance to connect the output cable 301 to the battery 3. The output connector 302 comprises conductive contacts 3021 electrically connecting with the output cable 301 and an insulative housing 3022 molded over the conductive contacts 3021 for convenient insertion and extraction of the user hand. The quantity of the conductive contacts 3021 is the same as that of the receptacle connector 3a of the battery 3. When using, the user hand exerts a force to the insulative housing 3022 of the output connector 302, and pulls the output cable 301 out of the reel box 10 a predetermined distance until the output connector 302 could be plugged into the receptacle connector 3a to form an electrical connection with the battery.

The restore mechanisms are capable of dragging the input cable 201 and the output cable 31 back to the reel box 10. In the preferred embodiment, the restore mechanisms are a pair of volute springs assembled in the reel box 10. The volute spring is fixed to the protruding shaft 104, and exerts a spring force to the input cable 201 or the output cable 301 for reeling the input cable 201 or the output cable 301 to the reel section 1041 of the protruding shaft 104. the stop section 1042 is capable of preventing the input cable 201 or the output cable 301 from moving upwardly when reeling. In an alternative embodiment, the input cable 201 and the output cable 301 also could be reeled to corresponding volute springs. After the input cable 201 and the output cable 301 are reeled to the reel sections 1041, the input cable 201 and the output cable 301 are located in the same plane which could reduce the total height of the reel box 10, that means the input cable 201 and the output cable 301 have the same height. Since the input cable 201 and the output cable 301 are reeled to different protruding shafts 104, the diameter of the reeled input cable or the reeled output cable could be reduced, thus reducing the width of the reel box 10.

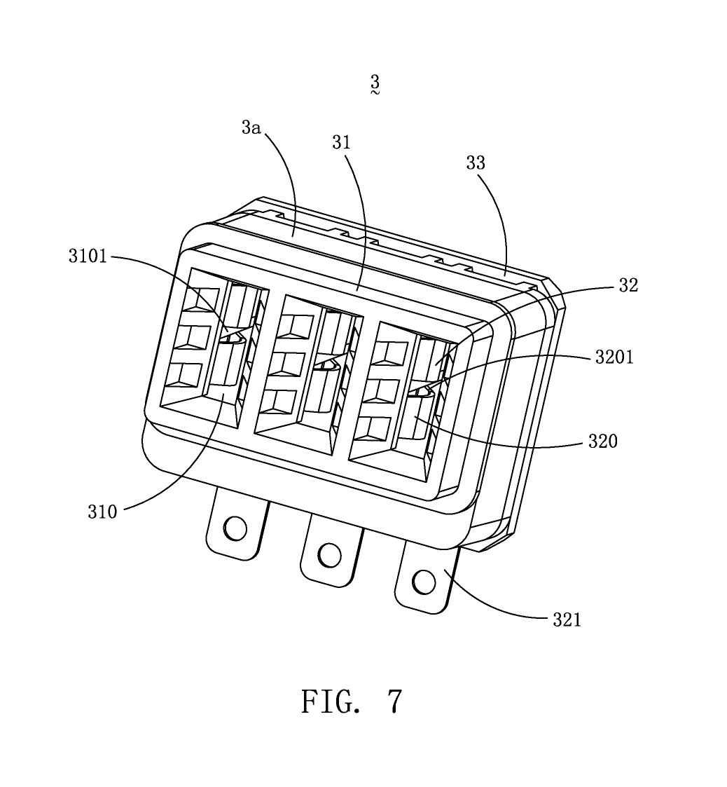

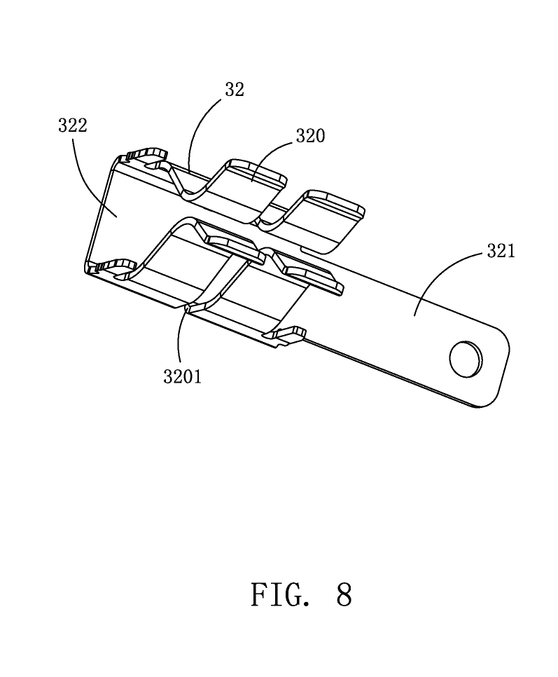

Please refer to FIGS. 7-8, the receptacle connector 3a of the battery 3 comprises an insulative seat 31, a plurality of terminals 32 received in the insulative seat 31, and a protection cover 33 covering the top of the insulative seat 31. The insulative seat 31 defines a plurality of through passages 310 for receiving the terminals 32 with a pair of ribs 3101 on inner walls of each through passage 31. The terminal 32 comprises a flat base portion 322, a pair of contacting portions 320 extending substantially vertically from opposite sides of the base portion 322 and curved toward each other, and a tail portion 321 extending out of the insulative seat 31. The terminal 32 is received in the through passage 310, and each contacting portion 320 of the terminal 32 is bifurcated and forms a slot 3201 to cooperate with corresponding rib 3101 for positioning the terminal 32 in the insulative seat 31.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed. For example, the tongue portion is extended in its length or is arranged on a reverse side thereof opposite to the supporting side with other contacts but still holding the contacts with an arrangement indicated by the broad general meaning of the terms in which the appended claims are expressed.

We claim:

1. A charger adapted for electrically connecting with a power supply system to charge a battery, comprising:
a reel box
an input port, comprising an input cable received in the reel box and an input connector connecting with the input cable, said input cable extends beyond the reel box a predetermined distance for providing an electrical connection between the input connector and said power supply system;
an output port, comprising an output cable receive(in the reel box and an output connector connecting with the output cable, said output cable extends beyond the reel box a predetermined distance for providing an electrical connection between the output connector and the battery;
restore mechanisms received in said reel box and capable of retracting the input cable and the output cable back into the reel box; and
a power converter received in said reel box, one end of the power converter is connected with the input port, and the other end of the power converter is connected with the output port.

2. The charger as claimed in claim 1, wherein the reel box comprises a receiving space for accommodating the input cable and the output cable.

3. The charger as claimed in claim 2, wherein the receiving space of the reel box is disposed with a pair of protruding shafts, said restore mechanisms is a pair of volute springs respectively fixed to the protruding shafts, said input cable is reeled to one protruding shaft under the spring force of one of the volute springs, while the output cable is reeled to the other protruding shaft under the spring force of the other volute spring.

4. The charger as claimed in claim 3, wherein said input cable and the output cable are reeled respectively to the volute springs.

5. The charger as claimed in claim 3, wherein the pair of protruding shafts is disposed spacedly, and the input cable and the output cable are located on the same plane after reeled to corresponding protruding shaft.

6. The charger as claimed in claim 3, wherein each protruding shaft comprises a reel section. with a relatively small diameter and a stop section located at a free end of the reel section with a relatively large diameter, wherein the input cable and the output cable are respectively reeled to the reel sections of the protruding shafts.

7. The charger as claimed in claim 6, wherein the receiving space of the reel box comprises spaced first receiving section and second receiving section, wherein one protruding shaft is disposed in the first receiving section and the input cable is received in the first receiving section, and the other protruding shaft is disposed in the second receiving section and the output cable is received in the second receiving section.

8. The charger as claimed in claim 2, wherein the reel box comprises a lower shell and an upper shell cooperating with the lower shell to form said receiving space.

9. The charger as claimed in claim 1, wherein the input cable and the output cable extend out of the reel box in opposite reverse direction.

10. A charging assembly adapted for connecting with a power supply system, comprising:
a battery for being charged comprising a receptacle connector;
a charger, comprising:
an input port, comprising an input cable received in the reel box and an input connector connecting with the input cable, said input cable extending beyond the reel box a predetermined distance for providing an electrical connection between the input connector and said power supply system;
an output port, comprising an output cable received in the reel box and a output connector connecting with the output cable, said output cable extending beyond the reel box a predetermined distance for providing an electrical. connection between the output connector and the receptacle connector of the battery;
restore mechanisms, received in said reel box and capable of pulling the input cable and the output cable back into the reel box; and
a power converter received in said reel box, one end of the power converter connecting with the input port, and the other end of the power converter connecting with the output port.

11. The charging assembly as claimed in claim 10, wherein the input cable and the output cable are capable of being dragged out of the reel box in opposite reverse directions.

12. The charging assembly as claimed in claim 10, wherein the receptacle connector comprises an insulative seat, a plurality of terminals received in the insulative seat and a protection cover covering the top of the insulative seat, and wherein the insulative seat defines a plurality of through passages to receive the terminals.

13. The charging assembly as claimed in claim 12, wherein each terminal comprises a contacting portion received in the through recess and a tail portion extending beyond the insulative seat, wherein the insulative seat forms at least one rib on an inner wall of the through passage, the contacting portion of the terminal cooperates with the rib to retain the terminal in the insulative seat.

14. The charging assembly as claimed in claim 13, wherein the contacting portion of the terminal is bifurcated and define a slot to cooperate with the rib of the insulative seat.

15. The charging assembly as claimed in claim 14, wherein the terminal further comprises a flat base portion, wherein a pair of contacting portions extends from opposite sides of the base portion.
